(19) United States
(12) Patent Application Publication
(10) Pub. No.: US 2026/0300596 A1
(43) Pub. Date: Oct. 1, 2026

(54) SYSTEM AND/OR METHOD FOR SELECTING CIRCUIT FEATURES FOR INTEGRATED CIRCUIT DIE

(71) Applicant: Arm Limited, Cambridge (GB)

(72) Inventors: Chetan Pinto, San Diego, CA (US); Kelageri Nagaraj, San Diego, CA (US); Duc Anh Tran, San Diego, CA (US); Raghavendra Rao Kota, San Diego, CA (US); Srinivasan Mohan, San Diego, CA (US); Uday Kiran Gangavelli, San Diego, CA (US); Neset Berkan Baran, San Diego, CA (US)

(21) Appl. No.: 19/092,840

(22) Filed: Mar. 27, 2025

(51) Int. Cl. G06F 30/392; G06F 119/06; G06F 119/12

(52) U.S. Cl. CPC G06F 30/392; G06F 2119/06; G06F 2119/12

(57) ABSTRACT

Subject matter disclosed herein relates to devices and techniques for determining aspects of a design for an integrated circuit (IC) die. In one embodiment, circuit implementation options for circuit cells in a design of an IC die may be selected based, at least in part, on associated delay characteristics and power metrics.

### BACKGROUND

### Field

This disclosure relates to techniques for selection of circuit implementations for circuit cells in an integrated circuit (IC) die.

### Information

Designs for an IC are typically derived from an abstraction of functional elements expressed as “standard cells” where circuit implementations of multiple cells may be integrated into a single IC die. For any particular cell in an abstracted IC die design, multiple circuit implementations may be available for selection from a library of circuit implementations. In one aspect, multiple different implementations for a particular cell in an IC die design may have different associated performance characteristics relating to power consumption and delay/latency.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of a system for determining an integrated circuit (IC) die design according to an embodiment;

FIG. 2 is a flow diagram of a process for selecting circuit implementations for circuit cells in an IC die design according to an embodiment;

FIG. 3 is a diagram of an example partitioning of elements of an IC die design according to an embodiment;

FIG. 4 is a flow diagram of a process for selecting circuit implementations for cells defining an IC die design according to an embodiment;

FIG. 5 is a schematic block diagram of an example computing system in accordance with an implementation; and

FIG. 6 is a schematic diagram of a system for manufacture of a device according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like indicates that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

According to an embodiment, a system and/or product incorporating integrated circuit (IC) devices (e.g., mobile phone, tablet computer or other mobile, computing components in a data center, etc.) may be implemented according to any one of several design constraints and/or goals. Such design constraints and/or goals may relate to, for example, reliability, performance accuracy, power consumption or execution delay/latency, just to provide a few examples of factors that may affect an overall product design. Power consumption and processing delay/latency of circuitry implemented for a design of an IC device incorporated in an integrated product may affect the overall power consumption and execution delay of the integrated product.

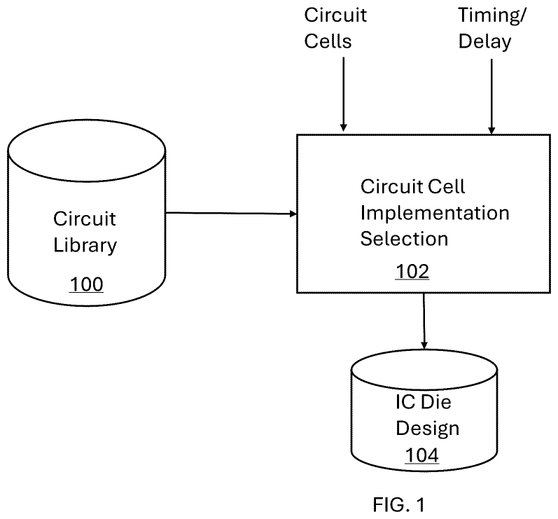

According to an embodiment, design of an IC device may expressed in a functional abstraction as “cells,” which may at least in part characterize particular functions of elements that are to be implemented in circuitry for integration in a single IC die. Such a cell may perform a particular function such as inverter, and, or, nand, nor, just to provide a few examples. As shown in FIG. 1 in an implementation, particular circuit implementations for circuit cells in a design of an IC die may be selected by a circuit cell implementation selection process 102 from a circuit library 100. Selection of such a particular circuit implementation may be subject to circuit constraints and/or requirements such as, for example, execution timing and/or delay. For any particular circuit cell, circuit library 100 may provide multiple different available circuit implementations for IC die design 104. According to an embodiment, circuit implementations of a particular circuit cell may be defined in circuit library 100 at least in part by a circuit layout having an arrangement and/or integration of transistors capable of performing a specified function of the particular circuit cell. In one implementation, circuit implementations in circuit library may be predefined according to processes at an integrated circuit device foundry, for example.

According to an embodiment, IC die design 104 may in whole or in part specify transistors and/or lower metal interconnects (not shown) in processes (e.g., front end-of-line and/or back-end-of-line processes) such as processes to form complementary metal oxide semiconductor (CMOS) circuitry, for example. In an implementation, IC die design 104 may be expressed, in whole or in part, using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions that may be implemented may include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

According to an embodiment, different circuit implementations in circuit library 100 as options for a particular circuit cell may have differing characteristics such as, for example, number of transistors, power consumption, execution delay, just to provide a few examples. Characteristics of power consumption and/or execution delay of a circuit implementation of a circuit cell in IC die design 104 may contribute to the overall power consumption and/or processing delay of an implementation of IC die design 104 in an IC product. Given a typical number of possible circuit implementations of any particular circuit cell in IC die design 104, there may be thousands of different possible combinations/permutations of possible circuit implementations for IC die design 104. Conventional methods for determining an optimal selection of circuit implementations for cells of an IC die using particular available computing resources may be computationally impractical and/or computationally intractable.

In one aspect, a method comprises: partitioning a design of an integrated circuit (IC) die into a plurality of partitions including a first plurality of first cells, each of the first cells are implementable by a plurality of selectable circuit implementation options, each of the selectable circuit implementation options having a power characteristic and a delay characteristic; for at least one partition of the plurality of partitions, identifying one or more of the first cells as having a dominant delay effect on timing paths in the at least one of the partition; for each of the identified first cells having a dominant delay effect on timing paths in the at least one partition, selecting a selectable circuit implementation option having a lowest delay characteristic; and for remaining unidentified first cells in the at least one partition, selecting circuit implementation options to achieve a defined timing goal for an implementation of the design of the IC die while minimizing a power metric for the implementation of the design of the IC die. By making an initial selection of circuit implementations for cells having a dominant latency effect on the design of an IC die, certain computational optimization techniques may be employed for selection of circuit implementations for remaining cells in the design of the IC die.

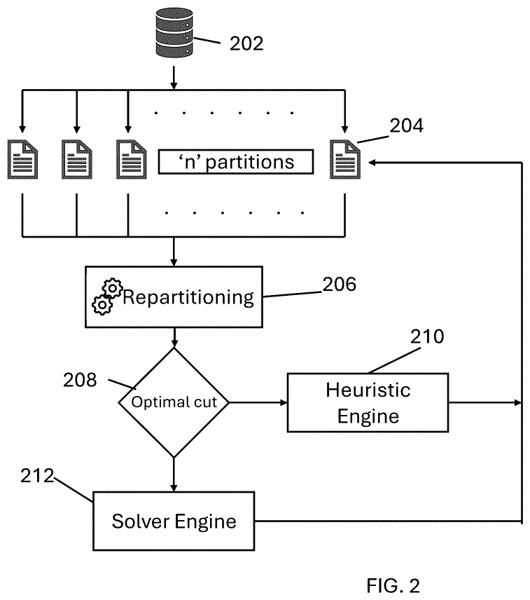

FIG. 2 is a flow diagram of a process 200 for selecting circuit implementations for circuit cells in an IC die design according to an embodiment. Abstracted design 202 may comprise an expression of aspects of an IC die design as a functional integration of circuit cells. In an implementation, at least some of the circuit cells may be expressed in terms of a function to be performed in an IC die without specifying particular circuit details (e.g., particular arrangement of transistors and/or lower metal interconnects). According to an embodiment, abstracted design 202 may be implemented in a finished IC die according to any one of multiple constraints and/or design goals such as, for example, number of transistors, process timing/delay and/or power consumption.

As pointed out above, for any particular circuit cell defined in abstracted design 202, there may be multiple different circuit implementations selectable from a circuit library. In one embodiment, different selectable circuit implementations for a particular circuit cell may be defined by different circuit topologies having different operational characteristics such as, for example, process timing delay and/or a power metric (e.g., current leakage, power). In an implementation, a single design characteristic for an implementation of a circuit cell may be indicative of multiple operational characteristics impacting constraints and/or design goals of abstracted design 202. One such operational characteristic of a circuit cell implementation, threshold voltage (V_{T}), cell may be indicative of power consumption and circuit delay for the circuit cell implementation. For example, a higher V_{T} for first circuit implementation relative to a V_{T} for second circuit implementation may indicate that the first circuit implementation operates using less power and with a longer delay than does the second circuit implementation.

In one aspect, an implementation of abstracted design 202 may comprise “timing paths” through which a sequence of circuit cell implementations may be designed to complete execution within a duration of an execution cycle (e.g., circuit clock cycle). In one aspect, a delay of such a timing path may be quantified as sum of respective delays of individual circuit cell implementations in the timing path executed in a sequence. For example, a timing path may be associated with a “slack” to indicate an amount by which such a sum of respective delays of individual circuit cell implementations exceeds the duration of an execution cycle. Conversely, a negative “slack” may indicate an amount by which such a sum of respective delays of individual circuit cell implementations is less than duration of an execution cycle for a timing path that is “in violation” of a timing constraint to complete execution within the duration of the execution cycle.

According to an embodiment, aspects of timing paths for a circuit implementation of abstracted design 202 may be expressed in a “timing report.” Such a timing report may identify particular timing paths in the circuit implementation that are “in violation” of the timing constraint to complete execution within the duration of the execution cycle. Such a timing report may also identify circuit cells in those timing paths that are “in violation.” In this context, a timing path in a circuit implementation that is “in violation” comprises a timing path that executed in a duration exceeding a an allowable execution time (e.g., an execution cycle).

According to an embodiment, abstracted design 202 may be implemented in an IC die design having timing paths that execute in less than a maximum circuit delay while having a smallest power consumption. In one implementation, an optimization process may initialize for each circuit cell of abstracted design 202 an initial circuit implementation having a highest V_{T} (e.g., lowest power and highest delay). For a timing path in the initial circuit implementation that is “in violation,” one or more circuit cell implementations may be replaced with circuit cell implementations that execute with a smaller delay so that a modified timing path may complete execution within an execution cycle for an IC die design.

In one embodiment, a more optimal selection of circuit implementations for circuit cells of design 202 may be determined using a linear programming optimization technique. In an embodiment, an initial circuit implementation of circuit cells in timing paths “in violation” may be initially selected as circuit cell implementations having a lowest associated power/current leakage. For circuit cells in timing paths of the initial circuit implementation “in violation,” the linear programming optimization technique may replace circuit implementations having a lowest associated power/current leakage with circuit implementations imparting a shorter delay. For example, circuit implementations for respective circuit cells in timing paths “in violation” may be selected using a linear programming optimization according to an objective function in expression (1) and subject to constraints in expressions (2) and (3) as follows:

$$minimize : {\sum }_{i ∈ C} {\sum }_{v ∈ V} ( {X}_{( i , v )} ⋆ Δ {I}_{( , iv )} ) ; \qquad ( 1 )$$

$${\sum }_{v ∈ V} {X}_{( i , v )} = 1 ; ∀ i ∈ C \qquad ( 2 )$$

$${\sum }_{i ∈ p} {\sum }_{v ∈ V} ( {X}_{( i , v )} ⋆ Δ {t}_{( i v )} ) + {slack}_{( p )} > = 0 ; ∀ p ∈ P , \qquad ( 3 )$$

where:
P is a set containing all timing paths “in violation”;
C is a set containing all circuit cells in P;
V is a set containing allowable circuit implementations for C;
slack₍ₚ₎ is a slack of path pϵP;
Δl_{(i,v)} is a leakage delta if circuit cell implementation iϵC is swapped for smaller delay (higher leakage) circuit implementation vϵV;
Δt_{(i,v)} is a timing delta (cell delay) if circuit cell implementation iϵC is swapped for smaller delay (higher leakage) circuit implementation vϵV; and
X_{(i,v)} is a linear programming variable, where X_{(i,v)}=1 if the decision is to swap circuit cell implementation iϵC to a smaller delay (e.g., higher leakage) circuit implementation vϵV and X_{(i,v)}=0 if the decision is to not swap the circuit cell implementation iϵC to a smaller delay (e.g., higher leakage) circuit implementation vϵV.

Optimizing an implementation of abstracted design 202 using a linear programming technique according to expressions (1), (2) and (3) considering all possible circuit implementations vϵV for circuit cells iϵC for all timing paths “in violation” at once may be computationally intractable. According to an embodiment, to provide a more practical optimization framework, “partitions” of abstracted design 202 may be individually optimized according to objectives/constraints. In one aspect, abstracted design 202 may be partitioned into an ‘n’ number of partitions 204. For example, circuit cells defined in abstracted design 202 may be grouped into different partitions 204 to include timing paths that are to execute concurrently in an execution cycle. In one embodiment, partitions 204 may cover all or portions of individual timing paths “in violation” as defined in a timing report for a circuit implementation of abstracted design 202.

Partitions 204 may be “balanced” at block 206 so that an equivalent number of circuit cells in timing paths “in violation” are allocated among different partitions 204. In some instances, a timing path identified in a timing report “in violation” may be included in more than one partition 204 and/or more than one partition defined by block 206. According to an embodiment, in addition to allocating an equivalent number circuit cells of timing paths “in violation” among partitions, block 206 may define partitions so as to reduce and/or minimize an extent to which timing paths “in violation” are included in multiple partitions. According to an embodiment, diamond 208 may determine whether partitions 204 may be separately optimized using a linear programming optimization technique (e.g., according to expressions (1), (2) and (3)). If diamond 208 determines that remaining undefined portions (e.g., in timing paths “in violation”) of one or more of the balanced partitions are too numerous and/or too complex to be solved according to such a linear programming optimization technique, heuristic engine 210 may selectively define circuit cells in each partition.

According to embodiment, for remaining undefined cells in timing paths “in violation” in each partition, heuristic engine 210 may identify particular undefined circuit cells having a dominant timing/delay effect on the partition. In an implementation, heuristic engine may compute a “preference” metric quantifying a timing/delay effect of a circuit cell according to expression (4) as follows:

$$Preference ∝ occurrences * \frac{Delay gain}{Leakage loss} , \qquad ( 4 )$$

where:
#occurrances is a number of occurrences/timing paths including the circuit cell;
Delay gain is a reduction in delay transitioning to a circuit implementation having a lowest V_{T} (e.g., lowest delay); and
Leakage Loss is an increase in leakage resulting from transitioning to the circuit implementation having the lowest V_{T}.

According to an embodiment, a value for #occurrances may be obtained from timing report of an associated circuit implementation. Heuristic engine 210 may then rank undefined circuit cells of a timing path in a partition according to preference values computed according to expression (4) in decreasing order from most preferred to least preferred. Undefined circuit cells (e.g., with an initial highest V_{T}/highest delay implementation) in a partition having the highest ranking Preference values heuristic engine 210 may be “heuristically pruned” by selecting circuit implementations for these undefined circuit cells having a lowest V_{T} (smallest delay). Based on remaining undefined circuit cells in partitions, a timing report may be recomputed. Based, at least in part, on the recomputed timing reports, remaining undefined circuit cells of timing paths in violation may be repartitioned at block 206.

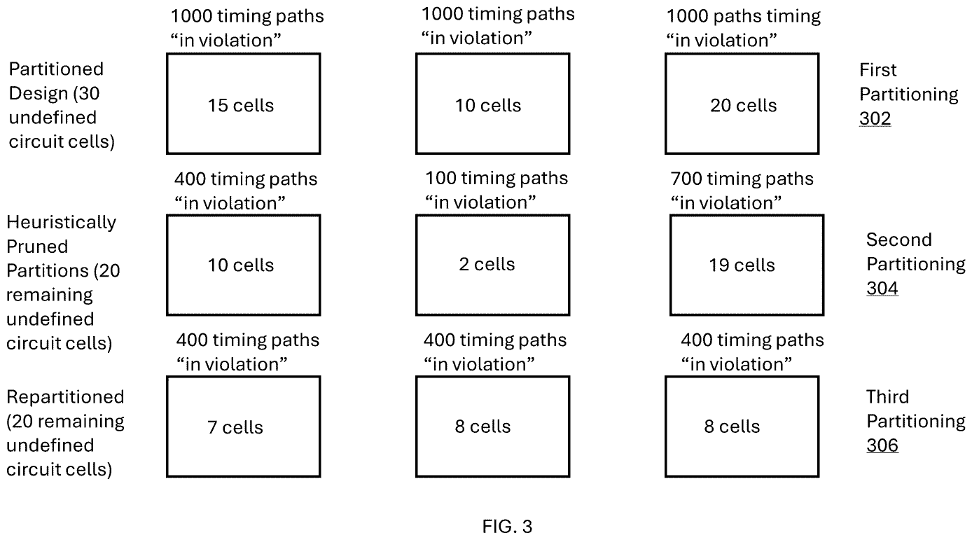

As pointed out above, block 206 may rebalance undefined circuit cells of timing paths “in violation” among resulting partitions. Block 206 may balance a number of cells of timing paths “in violation” contained within each partition while reducing and/or minimizing instances of timing paths “in violation” being covered by multiple resulting partitions. This is illustrated by example in FIG. 3. As pointed out above, for some circuit cells in a timing path “in violation,” heuristic engine 210 may select particular circuit cell implementations (e.g., circuit cell implementations having a smallest delay) while one or more other circuit cells in the timing path may remain “undefined” (e.g., in an initial implementation with a lowest power/highest delay). In a first partitioning 302, 30 undefined circuit cells of an IC die design may initially be allocated among three partitions; a first partition containing 15 undefined circuit cells; a second partition containing 10 circuit cells and a third partition containing 20 undefined circuit cells. In first partitioning 302, each of the three partitions include 1000 timing paths that are “in violation” (e.g., having a total timing path delay exceeding an execution cycle duration). If it is determined at diamond 208 that an optimal selection of the 30 undefined circuit cells in first partitioning 302 is computationally intractable given particular computing resources, heuristic engine 206 may select lowest V_{T} circuit (e.g., lowest/smallest delay) implementations for undefined circuit cells having a dominant delay effect (e.g., according to expression (4)).

In the particular example of FIG. 3, heuristic engine 206 may define or “prune” ten of 30 undefined circuit cells to provide a second partitioning 304 with a remaining 20 circuit cells: 10 circuit cells in the first partition; two circuit cells in the second partition and 19 cells in the third partition (with some cells in two or more partitions). Here, a recomputed timing report may indicate the first partition with 400 timing paths in violation, the second partition with 100 timing paths “in violation” and the third partition with 700 timing paths “in violation. To rebalance these partitions heuristically pruned at block 210, block 206 may repartition the 20 remaining undefined circuit cells in a third partitioning 306 by allocating seven undefined circuit cells to a first partition, eight undefined circuit cells to a second partition and eight undefined circuit cells to a third partition. In third partitioning 306, each partition may have 400 timing paths “in violation.”

If diamond 208 determines that a given set of computation resources is capable of computing an optimal selection of circuit implementations for the remaining 20 undefined circuit cells of third partitioning 306, solver engine 212 may determine circuit implementations of the remaining 20 undefined circuit cells according to expressions (1), (2) and (3). Otherwise, heuristic engine 210 may heuristically prune the remaining 20 undefined circuit cells in third partitioning 306 by selecting circuit implementations for these undefined circuit cells having a lowest V_{T} (smallest delay) as discussed above.

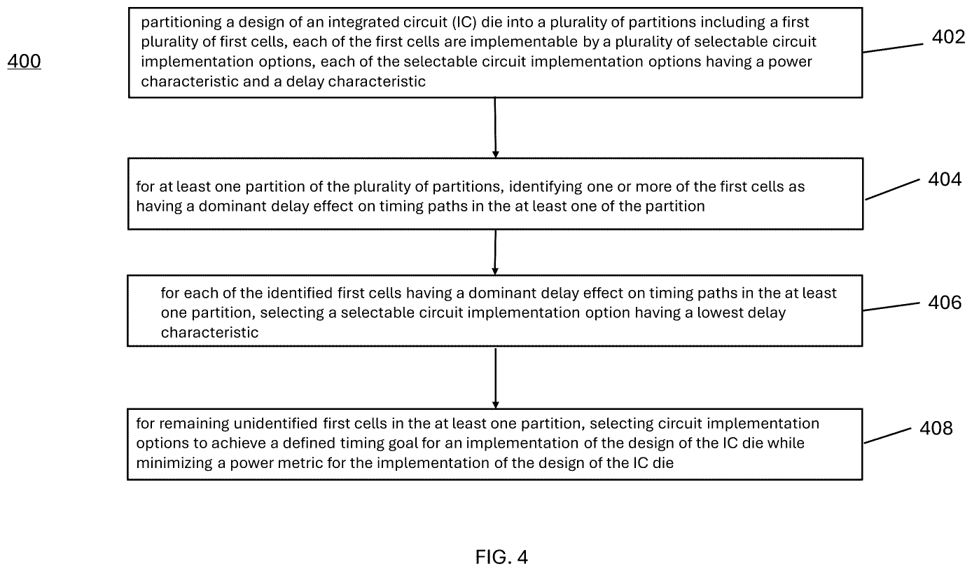

FIG. 4 is a flow diagram of a process 400 for selecting circuit implementations for cells defining an IC die design according to an embodiment. Block 402 may comprise determining a partitioning of abstracted design 202 so that partitions 204 contain an equivalent number of undefined circuit cells in an equivalent number of timing paths “in violation.” Based at least in part on timing reports, block 402 may determine an allocation of circuit cells among partitions 204 so that a minimal number of timing paths cross multiple partitions.

If it is determined that a process for optimally selecting circuit implementations for cells in partitions determined in block 402 would be computationally intractable given particular computing resources, block 404 may identify circuit cells in a partition having a dominant delay effect on timing paths in the partition. For example, block 404 may identify circuit cells in a partition having a dominant delay effect according to heuristic engine 210 and as set forth in expression (4). For circuit cells identified in block 404 having a dominant delay effect, block 406 may select circuit implementations having a lowest delay characteristic. For example, block 406 may select circuit implementations having a lowest V_{T}.

For remaining circuit cells in a partition of block 402 that are not identified at block 404 as having a dominant delay effect, block 408 may select circuit implementation options to achieve a timing goal for an implementation of the design of the IC die while minimizing power consumption. For example, block 408 may employ a linear programming optimization technique as set forth in expressions (1), (2) and (3).

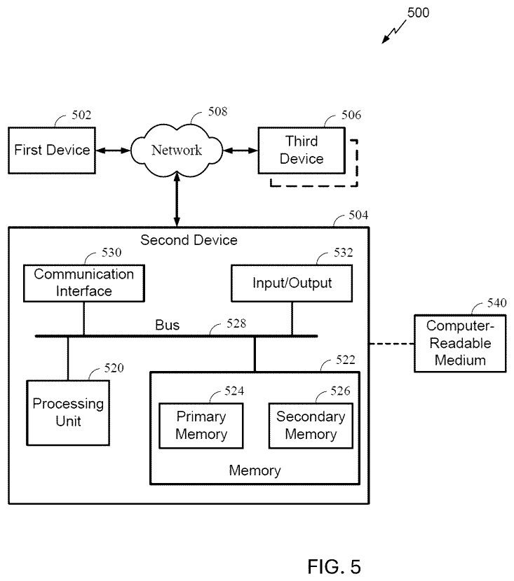

According to an embodiment, one or more aspects of process 400 may be performed by a computing device. Aspects of such a computing device are shown by example in FIG. 5 according to an embodiment. In particular implementations, example devices in FIG. 5 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that interprets and executes instructions to process input signals to provide output signals. As such, in the context of the present patent application at least, computing device and/or processor are understood to refer to sufficient structure within the meaning of 35 USC § 112 (f) so that it is specifically intended that 35 USC § 112 (f) not be implicated by use of the term “computing device.” “processor” and/or similar terms; however, if it is determined, for some reason not immediately apparent, that the foregoing understanding cannot stand and that 35 USC § 112 (f), therefore, necessarily is implicated by the use of the term “computing device.” “processor” and/or similar terms, then, it is intended, pursuant to that statutory section, that corresponding structure, material and/or acts for performing one or more operations and/or functions be understood and be interpreted to be described at least in FIG. 4 and in the text associated with the foregoing figure(s) of the present patent application.

In one example embodiment, as shown in FIG. 5, a system embodiment may comprise a local network (e.g., device 504 and medium 540) and/or another type of network, such as a computing and/or communications network. For purposes of illustration, therefore, FIG. 5 shows an embodiment 500 of a system that may be employed to implement either type or both types of networks. Network 508 may comprise one or more network connections, links, processes, services, applications, and/or resources to facilitate and/or support communications, such as an exchange of communication signals, for example, between a computing device, such as 502, and another computing device, such as 506, which may, for example, comprise one or more client computing devices and/or one or more server computing device. By way of example, but not limitation, network 508 may comprise wireless and/or wired communication links, telephone and/or telecommunications systems, Wi-Fi networks, Wi-MAX networks, the Internet, a local area network (LAN), a wide area network (WAN), or any combinations thereof.

In FIG. 5, computing device 502 may provide one or more sources of executable computer instructions in the form physical states and/or signals (e.g., stored in memory states), for example. Computing device 502 may communicate with computing device 504 by way of a network connection, such as via network 508, for example. As previously mentioned, a connection, while physical, may not necessarily be tangible. Although computing device 504 of FIG. 5 shows various tangible, physical components, claimed subject matter is not limited to computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 522 may comprise any non-transitory storage mechanism. Memory 522 may comprise, for example, primary memory 524 and secondary memory 526, additional memory circuits, mechanisms, or combinations thereof may be used. Memory 522 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 522 may be utilized to store a program of executable computer instructions. For example, processor 520 may fetch executable instructions from memory and proceed to execute the fetched instructions. Memory 522 may also comprise a memory controller for accessing device readable-medium 540 that may carry and/or make accessible digital content, which may include code, and/or instructions, for example, executable by processor 520 and/or some other device, such as a controller, as one example, capable of executing computer instructions, for example. Under direction of processor 520, a non-transitory memory, such as memory cells storing physical states (e.g., memory states), comprising, for example, a program of executable computer instructions, may be executed by processor 520 and able to generate signals to be communicated via a network, for example, as previously described. Generated signals may also be stored in memory, also previously suggested.

Memory 522 may store electronic files and/or electronic documents, such as relating to one or more users, and may also comprise a computer-readable medium that may carry and/or make accessible content, including code and/or instructions, for example, executable by processor 520 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted that an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

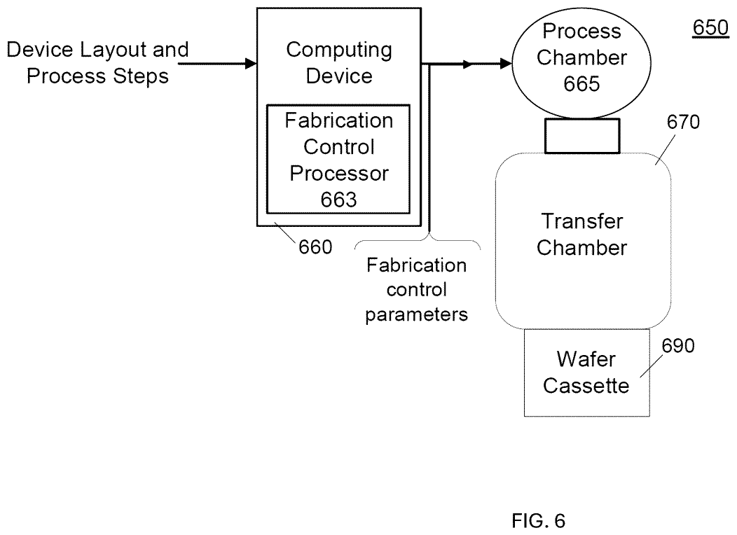

FIG. 6 is a schematic diagram of a system for forming IC dies according to an embodiment 650. According to an embodiment, computing device 660 may determine fabrication control parameters based, at least in part, on particular device layout and process steps (e.g., device layout and process steps determined based, at least in part, on IC die design 104, FIG. 4). According to an embodiment, layers of material to form an IC die according to IC die design 104 (FIG. 1) may be formed in process chamber 665 using any one of several suitable deposition processes such as, for example, atomic layer deposition, chemical vapor deposition, plasma chemical vapor deposition, sputter deposition, physical vapor deposition, hot wire chemical vapor deposition, laser enhanced chemical vapor deposition, laser enhanced atomic layer deposition, rapid thermal chemical vapor deposition, spin on deposition, gas cluster ion beam deposition, and/or the like, utilized in fabrication of IC dies from materials presently available and/or to be available in the future.

In embodiment 650, computing device 660 may generate particular device settings and other control parameters to be utilized by process chamber 665, transfer chamber 670, and wafer cassette 690 based, at least in part, on device layout and process steps (e.g., based, at least in part, on IC die design 104, FIG. 1). For example, responsive to computing device 660 obtaining device layout and process steps, fabrication control processor 663 may operate to specify fabrication control parameters, such as particular materials including host materials and dopant precursors to be employed in deposition, chamber pressure, annealing temperatures, exposure durations, and a variety of additional settings utilized by process chamber 665, and claimed subject matter is not limited in this respect. In embodiments, after fabrication of one or more wafers comprising processor devices, storage devices and/or inter-device communication devices, process chamber may transport fabricated wafers to wafer cassette 690 for singulation and/or other postprocessing of wafers.

In an embodiment, computing device 660 may comprise a memory or storage device, which may include primary and secondary memories, which may communicate with control fabrication processor 663. Computing device 660 may utilize, for example, an internal bus structure.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second,” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

In the preceding description, various aspects of claimed subject matter have been described. For purposes of explanation, specifics, such as amounts, systems, and/or configurations, as examples, were set forth. In other instances, well-known features were omitted and/or simplified so as not to obscure claimed subject matter. While certain features have been illustrated and/or described herein, many modifications, substitutions, changes, and/or equivalents will occur to those skilled in the art. It is, therefore, to be understood that the appended claims are intended to cover all modifications and/or changes as fall within claimed subject matter.

Some embodiments may be described, at least in part, by the following numbered clauses or by any combination thereof:
Clause 1: A method comprising:
   partitioning a design of an integrated circuit (IC) die into a plurality of first partitions including a first plurality of first cells, each of the first cells are implementable by a plurality of selectable circuit implementation options, each of the selectable circuit implementation options having a power characteristic and a delay characteristic;
   for at least one first partition of the plurality of first partitions, identifying one or more of the first cells as having a dominant delay effect on timing paths in the at least one first partition;
   for each of the identified one or more of the first cells having a dominant delay effect on timing paths in the at least one first partition, selecting a selectable circuit implementation option having a lowest delay characteristic; and
   for remaining unidentified first cells in the at least one first partition, selecting circuit implementation options to achieve a defined timing goal for an implementation of the design of the IC die while minimizing a power metric for the implementation of the design of the IC die.
Clause 2: The method of clause 1, wherein selecting circuit implementation options to achieve a defined timing goal for an implementation of the design of the IC die while minimizing a power metric for the implementation of the design of the IC die further comprises executing a linear programming operation to minimize the power metric subject to a timing constraint for the design of the IC die.
Clause 3: The method of clause 1 or clause 2, wherein identifying one or more of the first cells as having a dominant delay effect on timing paths in the at least one first partition the design of the IC die further comprises:
   for each of at least some of the first cells in the at least one first partition, computing a preference metric based, at least in part, on a number of occurrences of the first cell in timing paths in the at least one first partition, a power loss metric of a circuit implementation option of the first cell having a lowest latency characteristic or a latency characteristic of the circuit implementation option of the first cell having a lowest latency characteristic, or a combination thereof; and ranking the first cells based on the computed preference metrics.
Clause 4: The method of any of clauses 1 to 3, and further comprising, responsive to a determination that an optimization model is not capable of determining circuit implementation options of the remaining unidentified first cells:
   selecting one or more of the remaining unidentified first cells as having a dominant delay effect on the design of the IC die;
   for each of the selected one or more of the remaining unidentified first cells having a dominant delay effect on the design of the IC die, selecting a selectable circuit implementation option having a lowest delay characteristic; and
   for remaining unselected cells, selecting circuit implementation options to achieve the defined timing goal for the implementation of the design of the IC die while minimizing the power metric for the implementation of the design of the IC die.
Clause 5: The method of clause 4, and further comprising, further responsive to determination that an optimization model is not capable of determining circuit implementation options of the remaining unidentified first cells:
   repartitioning the design into a plurality of second partitions including a plurality of second cells based, at least in part, on circuit implementations selected for the identified one or more of the first cells having a dominant latency effect on the design of the IC die;
   computing delay characteristics of selectable circuit implementation options for the plurality of second cells based, at least in part, on the repartitioning;
   for at least one second partition of the plurality of second partitions, identifying one or more of the second cells as having a dominant latency effect on the design of the IC die;
   for each of the identified one or more of the second cells having a dominant latency effect on the design of the IC die, selecting a selectable circuit implementation option having a lowest latency characteristic; and
   for remaining unidentified second cells, selecting circuit implementation options to achieve a defined latency goal for an implementation of the design of the IC die while minimizing a power metric for the implementation of the design of the IC die.
Clause 6: The method of any of clauses 1 through 5, and further comprising:
   determining an initial implementation design of the IC die to include selection of a lowest power characteristic for one or more circuit cells in the IC die;
   computing a first timing report to identify one or more first timing paths, each of the first timing paths to include a sequence of circuit cell implementations in the initial implementation design to be executed within a duration of a predetermined execution cycle of an implementation of the IC die; and
   identifying first timing paths having a resulting execution time that exceeds the duration of the predetermined execution cycle, wherein:
   each of the first partitions includes circuit cells in at least one of the identified first timing paths.
Clause 7: The method of clause 6, and further comprising, responsive to a determination that an optimization model is not capable of determining circuit implementation options of the remaining unidentified first cells:
   selecting one or more of the remaining unidentified first cells as having a dominant delay effect on the design of the IC die;
   for each of the selected one or more of the remaining unidentified first cells having a dominant delay effect on the design of the IC die, selecting a selectable circuit implementation option having a lowest delay characteristic to provide a modified implementation design of the IC die; and
   computing a second timing report to identify one or more second timing paths, each of the second timing paths to include a sequence of circuit cell implementations in the modified implementation design to be executed within the duration of the predetermined execution cycle.
Clause 8: The method of clause 7, and further comprising:
   identifying second timing paths having a resulting execution time that exceeds the duration of the predetermined execution cycle; and
   partitioning the modified implementation design into a plurality of second partitions including a second plurality of second cells based, at least in part, on circuit implementations selected for the identified one or more of the first cells having a dominant latency effect on the design of the IC die, wherein:
   each of the second partitions includes circuit cells in at least one of the identified second timing paths.
Clause 9: An article comprising:
   a storage medium comprising computer-readable instructions stored thereon that are executable by one or more processors of a computing device to:
   partition a design of an integrated circuit (IC) die into a plurality of first partitions including a first plurality of first cells, each of the first cells are implementable by a plurality of selectable circuit implementation options, each of the selectable circuit implementation options having a power characteristic and a delay characteristic;
   for at least one first partition of the plurality of first partitions, identify one or more of the first cells as having a dominant delay effect on timing paths in the at least one first partition;
   for each of the identified one or more of the first cells having a dominant delay effect on timing paths in the at least one first partition, select a selectable circuit implementation option having a lowest delay characteristic; and
   for remaining unidentified first cells in the at least one first partition, select circuit implementation options to achieve a defined timing goal for an implementation of the design of the IC die while minimizing a power metric for the implementation of the design of the IC die.
Clause 10: The article of clause 9, wherein selection of the selectable circuit implementation options to achieve the defined timing goal for the implementation of the design of the IC die while minimizing a power metric for the implementation of the design of the IC die further to comprise execution of a linear programming operation to minimize the power metric subject to a timing constraint for the design of the IC die.
Clause 11: The article of clause 9 or clause 10, wherein to identify one or more of the first cells as having the dominant delay effect on timing paths in the at least one first partition the design of the IC die, the instructions are further executable by the one or more processors to:
   for each of at least some of the first cells in the at least one first partition, compute a preference metric based, at least in part, on a number of occurrences of the first cell in timing paths in the at least one first partition, a power loss metric of a circuit implementation option of the first cell having a lowest latency characteristic or a latency characteristic of the circuit implementation option of the first cell having a lowest latency characteristic, or a combination thereof; and rank the first cells based on the computed preference metrics.
Clause 12: The article of any of clauses 9 to 11, wherein responsive to a determination that an optimization model is not capable of determining circuit implementation options of the remaining unidentified first cells, the instructions are further executable by one or more processors to:
   select one or more of the remaining unidentified first cells as having a dominant delay effect on the design of the IC die;
   for each of the selected one or more of the remaining unidentified first cells having a dominant delay effect on the design of the IC die, select a selectable circuit implementation option having a lowest delay characteristic; and
   for remaining unselected cells, select circuit implementation options to achieve the defined timing goal for the implementation of the design of the IC die while minimizing the power metric for the implementation of the design of the IC die.
Clause 13: The article of clause 12, wherein further responsive to determination that an optimization model is not capable of determining circuit implementation options of the remaining unidentified first cells, the instructions are further executable by the one or more processors to:
   repartition the design into a plurality of second partitions including a plurality of second cells based, at least in part, on circuit implementations selected for the identified one or more of the first cells having a dominant latency effect on the design of the IC die;
   compute delay characteristics of selectable circuit implementation options for the plurality of second cells based, at least in part, on the repartitioning;
   for at least one second partition of the plurality of second partitions, identify one or more of the second cells as having a dominant latency effect on the design of the IC die;
   for each of the identified one or more of the second cells having a dominant latency effect on the design of the IC die, select a selectable circuit implementation option having a lowest latency characteristic; and
   for remaining unidentified second cells, select circuit implementation options to achieve a defined latency goal for an implementation of the design of the IC die while minimizing a power metric for the implementation of the design of the IC die.
Clause 14: The article of any of clauses 9 to 13, wherein the instructions are further executable by the one or more processors to:
   determining an initial implementation design of the IC die to include selection of a lowest power characteristic for one or more circuit cells in the IC die;
   computing a first timing report to identify one or more first timing paths, each of the first timing paths to include a sequence of circuit cell implementations in the initial implementation design to be executed within a duration of a predetermined execution cycle of an implementation of the IC die; and
   identifying first timing paths having a resulting execution time that exceeds the duration of the predetermined execution cycle, wherein:
   each of the first partitions includes circuit cells in at least one of the identified first timing paths.
Clause 15: An apparatus, the apparatus comprising:
   a memory; and
   one or more processors coupled to the memory to:
   partition a design of an integrated circuit (IC) die into a plurality of first partitions including a first plurality of first cells, each of the first cells are implementable by a plurality of selectable circuit implementation options, each of the selectable circuit implementation options having a power characteristic and a delay characteristic;
   for at least one first partition of the plurality of first partitions, identify one or more of the first cells as having a dominant delay effect on timing paths in the at least one first partition;
   for each of the identified one or more of the first cells having a dominant delay effect on timing paths in the at least one first partition, select a selectable circuit implementation option having a lowest delay characteristic; and
   for remaining unidentified first cells in the at least one first partition, select circuit implementation options to achieve a defined timing goal for an implementation of the design of the IC die while minimizing a power metric for the implementation of the design of the IC die.
Clause 16: The apparatus of clause 15, wherein selection of circuit implementation options to achieve the defined timing goal for an implementation of the design of the IC die while minimizing a power metric for the implementation of the design of the IC die to further comprise execution of a linear programming operation to minimize the power metric subject to a timing constraint for the design of the IC die.
Clause 17: The apparatus of clause 15 or clause 16, wherein identification of the one or more of the first cells as having a dominant delay effect on timing paths in the at least one first partition the design of the IC die to further comprise:
   for each of at least some of the first cells in the at least one first partition, computation of a preference metric based, at least in part, on a number of occurrences of the first cell in timing paths in the at least one first partition, a power loss metric of a circuit implementation option of the first cell having a lowest latency characteristic or a latency characteristic of the circuit implementation option of the first cell having a lowest latency characteristic, or a combination thereof; and
   rank the first cells based on the computed preference metrics.
Clause 18: The apparatus of any of clauses 15 to 17, and wherein the one or more processors are further to:
   determine an initial implementation design of the IC die to include selection of a lowest power characteristic for one or more circuit cells in the IC die;
   compute a first timing report to identify one or more first timing paths, each of the first timing paths to include a sequence of circuit cell implementations in the initial implementation design to be executed within a duration of a predetermined execution cycle of an implementation of the IC die; and
   identify first timing paths having a resulting execution time that exceeds the duration of the predetermined execution cycle, wherein:
   each of the first partitions includes circuit cells in at least one of the identified first timing paths.
Clause 19: The apparatus of clause 18, wherein responsive to a determination that an optimization model is not capable of determining circuit implementation options of the remaining unidentified first cells, the one or more processors are further to:
   select one or more of the remaining unidentified first cells as having a dominant delay effect on the design of the IC die;
   for each of the selected one or more of the remaining unidentified first cells having a dominant delay effect on the design of the IC die, select a selectable circuit implementation option having a lowest delay characteristic to provide a modified implementation design of the IC die; and
   compute a second timing report to identify one or more second timing paths, each of the second timing paths to include a sequence of circuit cell implementations in the modified implementation design to be executed within the duration of the predetermined execution cycle.
Clause 20: The apparatus of clause 19, wherein the one or more processors are further to:
   identify second timing paths having a resulting execution time that exceeds the duration of the predetermined execution cycle; and
   partition the modified implementation design into a plurality of second partitions including a second plurality of second cells based, at least in part, on circuit implementations selected for the identified one or more of the first cells having a dominant latency effect on the design of the IC die, wherein:
   each of the second partitions includes circuit cells in at least one of the identified second timing paths.

What is claimed is:

1. A method comprising:
partitioning a design of an integrated circuit (IC) die into a plurality of first partitions including a first plurality of first cells, each of the first cells are implementable by a plurality of selectable circuit implementation options, each of the selectable circuit implementation options having a power characteristic and a delay characteristic;
for at least one first partition of the plurality of first partitions, identifying one or more of the first cells as having a dominant delay effect on timing paths in the at least one first partition;
for each of the identified one or more of the first cells having a dominant delay effect on timing paths in the at least one first partition, selecting a selectable circuit implementation option having a lowest delay characteristic; and
for remaining unidentified first cells in the at least one first partition, selecting circuit implementation options to achieve a defined timing goal for an implementation of the design of the IC die while minimizing a power metric for the implementation of the design of the IC die.

2. The method of claim 1, wherein selecting circuit implementation options to achieve a defined timing goal for an implementation of the design of the IC die while minimizing a power metric for the implementation of the design of the IC die further comprises executing a linear programming operation to minimize the power metric subject to a timing constraint for the design of the IC die.

3. The method of claim 1, wherein identifying one or more of the first cells as having a dominant delay effect on timing paths in the at least one first partition the design of the IC die further comprises:
for each of at least some of the first cells in the at least one first partition, computing a preference metric based, at least in part, on a number of occurrences of the first cell in timing paths in the at least one first partition, a power loss metric of a circuit implementation option of the first cell having a lowest latency characteristic or a latency characteristic of the circuit implementation option of the first cell having a lowest latency characteristic, or a combination thereof; and
ranking the first cells based on the computed preference metrics.

4. The method of claim 1, and further comprising, responsive to a determination that an optimization model is not capable of determining circuit implementation options of the remaining unidentified first cells:
selecting one or more of the remaining unidentified first cells as having a dominant delay effect on the design of the IC die;
for each of the selected one or more of the remaining unidentified first cells having a dominant delay effect on the design of the IC die, selecting a selectable circuit implementation option having a lowest delay characteristic; and
for remaining unselected cells, selecting circuit implementation options to achieve the defined timing goal for the implementation of the design of the IC die while minimizing the power metric for the implementation of the design of the IC die.

5. The method of claim 4, and further comprising, further responsive to determination that an optimization model is not capable of determining circuit implementation options of the remaining unidentified first cells:
repartitioning the design into a plurality of second partitions including a plurality of second cells based, at least in part, on circuit implementations selected for the identified one or more of the first cells having a dominant latency effect on the design of the IC die;
computing delay characteristics of selectable circuit implementation options for the plurality of second cells based, at least in part, on the repartitioning;
for at least one second partition of the plurality of second partitions, identifying one or more of the second cells as having a dominant latency effect on the design of the IC die;
for each of the identified one or more of the second cells having a dominant latency effect on the design of the IC die, selecting a selectable circuit implementation option having a lowest latency characteristic; and
for remaining unidentified second cells, selecting circuit implementation options to achieve a defined latency goal for an implementation of the design of the IC die while minimizing a power metric for the implementation of the design of the IC die.

6. The method of claim 1, and further comprising:
determining an initial implementation design of the IC die to include selection of a lowest power characteristic for one or more circuit cells in the IC die;
computing a first timing report to identify one or more first timing paths, each of the first timing paths to include a sequence of circuit cell implementations in the initial implementation design to be executed within a duration of a predetermined execution cycle of an implementation of the IC die; and
identifying first timing paths having a resulting execution time that exceeds the duration of the predetermined execution cycle, wherein:
each of the first partitions includes circuit cells in at least one of the identified first timing paths.

7. The method of claim 6, and further comprising, responsive to a determination that an optimization model is not capable of determining circuit implementation options of the remaining unidentified first cells:
selecting one or more of the remaining unidentified first cells as having a dominant delay effect on the design of the IC die;
for each of the selected one or more of the remaining unidentified first cells having a dominant delay effect on the design of the IC die, selecting a selectable circuit implementation option having a lowest delay characteristic to provide a modified implementation design of the IC die; and
computing a second timing report to identify one or more second timing paths, each of the second timing paths to include a sequence of circuit cell implementations in the modified implementation design to be executed within the duration of the predetermined execution cycle.

8. The method of claim 7, and further comprising:
identifying second timing paths having a resulting execution time that exceeds the duration of the predetermined execution cycle; and
partitioning the modified implementation design into a plurality of second partitions including a second plurality of second cells based, at least in part, on circuit implementations selected for the identified one or more of the first cells having a dominant latency effect on the design of the IC die, wherein:
each of the second partitions includes circuit cells in at least one of the identified second timing paths.

9. An article comprising:
a storage medium comprising computer-readable instructions stored thereon that are executable by one or more processors of a computing device to:
partition a design of an integrated circuit (IC) die into a plurality of first partitions including a first plurality of first cells, each of the first cells are implementable by a plurality of selectable circuit implementation options, each of the selectable circuit implementation options having a power characteristic and a delay characteristic;
for at least one first partition of the plurality of first partitions, identify one or more of the first cells as having a dominant delay effect on timing paths in the at least one first partition;
for each of the identified one or more of the first cells having a dominant delay effect on timing paths in the at least one first partition, select a selectable circuit implementation option having a lowest delay characteristic; and
for remaining unidentified first cells in the at least one first partition, select circuit implementation options to achieve a defined timing goal for an implementation of the design of the IC die while minimizing a power metric for the implementation of the design of the IC die.

10. The article of claim 9, wherein selection of the selectable circuit implementation options to achieve the defined timing goal for the implementation of the design of the IC die while minimizing a power metric for the implementation of the design of the IC die further to comprise execution of a linear programming operation to minimize the power metric subject to a timing constraint for the design of the IC die.

11. The article of claim 9, wherein to identify one or more of the first cells as having the dominant delay effect on timing paths in the at least one first partition the design of the IC die, the instructions are further executable by the one or more processors to:
for each of at least some of the first cells in the at least one first partition, compute a preference metric based, at least in part, on a number of occurrences of the first cell in timing paths in the at least one first partition, a power loss metric of a circuit implementation option of the first cell having a lowest latency characteristic or a latency characteristic of the circuit implementation option of the first cell having a lowest latency characteristic, or a combination thereof; and
rank the first cells based on the computed preference metrics.

12. The article of claim 9, wherein responsive to a determination that an optimization model is not capable of determining circuit implementation options of the remaining unidentified first cells, the instructions are further executable by one or more processors to:
select one or more of the remaining unidentified first cells as having a dominant delay effect on the design of the IC die;
for each of the selected one or more of the remaining unidentified first cells having a dominant delay effect on the design of the IC die, select a selectable circuit implementation option having a lowest delay characteristic; and
for remaining unselected cells, select circuit implementation options to achieve the defined timing goal for the implementation of the design of the IC die while minimizing the power metric for the implementation of the design of the IC die.

13. The article of claim 12, wherein further responsive to determination that an optimization model is not capable of determining circuit implementation options of the remaining unidentified first cells, the instructions are further executable by the one or more processors to:
repartition the design into a plurality of second partitions including a plurality of second cells based, at least in part, on circuit implementations selected for the identified one or more of the first cells having a dominant latency effect on the design of the IC die;
compute delay characteristics of selectable circuit implementation options for the plurality of second cells based, at least in part, on the repartitioning;
for at least one second partition of the plurality of second partitions, identify one or more of the second cells as having a dominant latency effect on the design of the IC die;
for each of the identified one or more of the second cells having a dominant latency effect on the design of the IC die, select a selectable circuit implementation option having a lowest latency characteristic; and
for remaining unidentified second cells, select circuit implementation options to achieve a defined latency goal for an implementation of the design of the IC die while minimizing a power metric for the implementation of the design of the IC die.

14. The article of claim 9, wherein the instructions are further executable by the one or more processors to:
determining an initial implementation design of the IC die to include selection of a lowest power characteristic for one or more circuit cells in the IC die;
computing a first timing report to identify one or more first timing paths, each of the first timing paths to include a sequence of circuit cell implementations in the initial implementation design to be executed within a duration of a predetermined execution cycle of an implementation of the IC die; and
identifying first timing paths having a resulting execution time that exceeds the duration of the predetermined execution cycle, wherein:
each of the first partitions includes circuit cells in at least one of the identified first timing paths.

15. An apparatus, the apparatus comprising:
a memory; and
one or more processors coupled to the memory to:
partition a design of an integrated circuit (IC) die into a plurality of first partitions including a first plurality of first cells, each of the first cells are implementable by a plurality of selectable circuit implementation options, each of the selectable circuit implementation options having a power characteristic and a delay characteristic;
for at least one first partition of the plurality of first partitions, identify one or more of the first cells as having a dominant delay effect on timing paths in the at least one first partition;
for each of the identified one or more of the first cells having a dominant delay effect on timing paths in the at least one first partition, select a selectable circuit implementation option having a lowest delay characteristic; and
for remaining unidentified first cells in the at least one first partition, select circuit implementation options to achieve a defined timing goal for an implementation of the design of the IC die while minimizing a power metric for the implementation of the design of the IC die.

16. The apparatus of claim 15, wherein selection of circuit implementation options to achieve the defined timing goal for an implementation of the design of the IC die while minimizing a power metric for the implementation of the design of the IC die to further comprise execution of a linear programming operation to minimize the power metric subject to a timing constraint for the design of the IC die.

17. The apparatus of claim 15, wherein identification of the one or more of the first cells as having a dominant delay effect on timing paths in the at least one first partition the design of the IC die to further comprise:
for each of at least some of the first cells in the at least one first partition, computation of a preference metric based, at least in part, on a number of occurrences of the first cell in timing paths in the at least one first partition, a power loss metric of a circuit implementation option of the first cell having a lowest latency characteristic or a latency characteristic of the circuit implementation option of the first cell having a lowest latency characteristic, or a combination thereof; and
rank the first cells based on the computed preference metrics.

18. The apparatus of claim 15, and wherein the one or more processors are further to:
determine an initial implementation design of the IC die to include selection of a lowest power characteristic for one or more circuit cells in the IC die;
compute a first timing report to identify one or more first timing paths, each of the first timing paths to include a sequence of circuit cell implementations in the initial implementation design to be executed within a duration of a predetermined execution cycle of an implementation of the IC die; and
identify first timing paths having a resulting execution time that exceeds the duration of the predetermined execution cycle, wherein:
each of the first partitions includes circuit cells in at least one of the identified first timing paths.

19. The apparatus of claim 18, wherein responsive to a determination that an optimization model is not capable of determining circuit implementation options of the remaining unidentified first cells, the one or more processors are further to:
select one or more of the remaining unidentified first cells as having a dominant delay effect on the design of the IC die;
for each of the selected one or more of the remaining unidentified first cells having a dominant delay effect on the design of the IC die, select a selectable circuit implementation option having a lowest delay characteristic to provide a modified implementation design of the IC die; and
compute a second timing report to identify one or more second timing paths, each of the second timing paths to include a sequence of circuit cell implementations in the modified implementation design to be executed within the duration of the predetermined execution cycle.

20. The apparatus of claim 19, wherein the one or more processors are further to:
identify second timing paths having a resulting execution time that exceeds the duration of the predetermined execution cycle; and
partition the modified implementation design into a plurality of second partitions including a second plurality of second cells based, at least in part, on circuit implementations selected for the identified one or more of the first cells having a dominant latency effect on the design of the IC die, wherein:
each of the second partitions includes circuit cells in at least one of the identified second timing paths.
